(19) United States
(12) Patent Application Publication
(10) Pub. No.: US 2025/0315670 A1
(43) Pub. Date: Oct. 9, 2025

(54) AUTONOMOUS AGENT SYSTEM FOR TRAINING DOMAIN LANGUAGE MODEL BASED ON LARGE LANGUAGE MODEL AND OPERATION METHOD THEREOF

(71) Applicant: ELECTRONICS AND TELECOMMUNICATIONS RESEARCH INSTITUTE, Daejeon (KR)

(72) Inventors: Euisok Chung, Daejeon (KR); Hyun Woo Kim, Daejeon (KR); Hwa Jeon Song, Daejeon (KR); Younghwan SHIN, Daejeon (KR); Jeongmin Yang, Daejeon (KR); Byunghyun Yoo, Daejeon (KR)

(21) Appl. No.: 19/035,230

(22) Filed: Jan. 23, 2025

(30) Foreign Application Priority Data
Apr. 5, 2024 (KR) 10-2024-0046617

(51) Int. Cl. G06N 3/08

(52) U.S. Cl. CPC G06N 3/08

(57) ABSTRACT

The present invention relates to an autonomous agent system for training a domain language model (DLM) based on a large language model (LLM) and an operating method thereof. The present invention proposes an approach that can overcome the dependency of the LLM in a multi-agent environment through a language model distillation procedure. The present invention proposes an autonomous agent technology that automates the process of consolidating experiences based on a memory by using a self-consistency technique and a chain-of-thought (CoT) reasoning.

### CROSS-REFERENCE TO RELATED APPLICATION

This application claims priority to and the benefit of Korean Patent Application No. 10-2024-0046617, filed on Apr. 5, 2024, the disclosure of which is incorporated herein by reference in its entirety.

### BACKGROUND

### 1. Field of the Invention

The present invention relates to a system for training a domain language model based on a large language model and an operating method thereof.

### 2. Description of Related Art

A large language model (LLM) is provided in an application programming interface (API) format and provides few-shot or zero-shot reasoning function through prompt-based in-context learning and chain-of-thought (CoT) (see references [1] and [2]).

Since the training parameters of the LLM are not disclosed, there is a problem that there is no other way to access the LLM other than the API provided by the LLM. To solve this problem, a distillation approach was proposed that uses the LLM as a teacher and a small pre-trained language model (PLM) as a student to enable CoT reasoning (see references [3] and [4]).

In addition, as the performance of the LLM has gradually improved, an autonomous multi-agent framework based on the LLM has been actively studied recently (see reference [5]).

The conventional LLM-based approach relies on paid services for using LLM and has a problem that the service cannot be provided on an independent server. While distillation for the PLM is a solution to this problem, a distillation method from the perspective of agents interacting with their environment and collaborating with other agents has not yet been proposed. In other words, an approach to replace the LLM using an autonomous agent based on the LLM has not yet to be presented.

### SUMMARY OF THE INVENTION

The present invention is directed to providing an autonomous agent system and an operating method thereof for training a domain language model based on a large language model (LLM). Through the system and method provided by the present invention, the domain language model can autonomously evolve, and an agent system using an independent domain language model becomes possible at the time of service of the model.

Specifically, the present invention is directed to providing an autonomous agent system and an operation method thereof for training a domain language model by distilling knowledge from the LLM in a situation where collaboration with other agents is possible while interaction with a domain environment is possible based on an autonomous agent.

The present invention follows a brain-mimicking approach for training a domain language model through a process of consolidation of memory-based experiences of an autonomous agent. Here, assuming that the hippocampus is a memory and the neo-cortex is an LLM, they collaborate to compress and store experiences in a remote memory, which is a domain language model.

The purpose of the present invention is not limited to the purpose mentioned above, and other purposes that are not mentioned will be clearly understood by those skilled in the art from the description below.

A method of training a domain language model (DLM) according to an embodiment of the present invention includes generating a chain-of-thought (CoT) for a previous input original prompt using the original prompt and large language model (LLM) and generating an expanded prompt by adding the CoT to the original prompt, acquiring a response by inputting the expanded prompt to the LLM and storing a pair of the expanded prompt and the response in a memory, sampling the pair of the expanded prompt and the response from the memory, and training a DLM using a result of the sampling.

The method of training the DLM according to an embodiment of the present invention is a method of training the DLM using one or more processors configured to execute instructions to operate an autonomous agent. The above method of training the DLM may include receiving, by the autonomous agent, an original prompt and generating a first expanded prompt by adding an instruction including an interaction target to the original prompt, acquiring, by the autonomous agent, a CoT including a subtask that is executed on the interaction target from an LLM using a CoT prompting technique based on the first expanded prompt, acquiring, by the autonomous agent, subtask execution result information by executing the subtask on the interaction target and generating a second expanded prompt by adding the subtask execution result information to the first expanded prompt; and acquiring, by the autonomous agent, a response by inputting the second expanded prompt to the LLM and storing a pair of the second expanded prompt and the response in a memory as training data of the DLM.

In an embodiment of the present invention, the method of training the DLM may further include performing, by the autonomous agent, sampling of the pair of an expanded prompt and the response in the memory, and training, by the autonomous agent, the DLM using a result of the sampling.

In an embodiment, the acquiring of the CoT may include acquiring, by the autonomous agent, the CoT including a subtask sequence from the LLM using the CoT prompting technique based on the first expanded prompt; and extracting, by the autonomous agent, a subtask that is executed on the interaction target from the subtask sequence.

In an embodiment, the interaction target may include at least one of an environment of the autonomous agent, the memory, and other agents, or a combination thereof.

In an embodiment, the training of the DLM may include augmenting, by the autonomous agent, the result of the sampling by additionally deriving a prompt that allows a response included in the result of the sampling to be derived, from the LLM by applying a self-consistency strategy.

In an embodiment, when the environment of the autonomous agent is included in the interaction target, the generating of the second expanded prompt may include transmitting, by the autonomous agent, a subtask that is executed on the environment as an action to the environment, and then adding observation acquired from the environment to the subtask execution result information.

An autonomous agent system according to an embodiment of the present invention is an autonomous agent system that trains a DLM. The autonomous agent system includes a memory configured to store computer-readable commands, and at least one processor implemented to execute the commands.

The at least one processor may execute the commands that cause an autonomous agent to receive an original prompt and generate a first expanded prompt by adding an instruction including an interaction target to the original prompt, acquire a CoT including a subtask that is executed on the interaction target from an LLM using a CoT prompting technique based on the first expanded prompt, acquire subtask execution result information by executing the subtask on the interaction target and generate a second expanded prompt by adding the subtask execution result information to the first expanded prompt, and acquire a response by inputting the second expanded prompt to the LLM and store a pair of the second expanded prompt and the response in the memory as training data of the DLM.

In an embodiment of the present invention, the at least one processor may be configured to cause the autonomous agent to perform sampling of a pair of an expanded prompt and the response in the memory and train the DLM using a result of the sampling.

In an embodiment of the present invention, the at least one processor may be configured to cause the autonomous agent to acquire the CoT including a subtask sequence from the LLM by using a CoT prompting technique based on the first expanded prompt in a process of acquiring the CoT and extract a subtask that is executed on the interaction target from the subtask sequence.

In an embodiment of the present invention, the interaction target may include at least one of an environment of the autonomous agent, the memory, and other agents, or a combination thereof.

In an embodiment of the present invention, the at least one processor may be configured to cause the autonomous agent to augment the result of the sampling by additionally deriving a prompt that allows a response included in the result of the sampling to be derived, from the LLM by applying a self-consistency strategy.

In an embodiment of the present invention, when the environment of the autonomous agent is included in the interaction target, the at least one processor may be configured to cause the autonomous agent to transmit a subtask that is executed on the environment as an action to the environment, and then add observation acquired from the environment to the subtask execution result information.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram illustrating an autonomous agent system according to the present invention;

FIG. 2 is a diagram illustrating a method of training a domain language model according to an embodiment of the present invention;

FIG. 3 is a diagram illustrating a method of acquiring a response using a domain language model according to an embodiment of the present invention;

FIG. 4 is a diagram illustrating a method of improving an action prediction model of an autonomous agent according to an embodiment of the present invention; and

FIG. 5 is a block diagram illustrating a configuration of an autonomous agent system according to an embodiment of the present invention.

### DETAILED DESCRIPTION OF EXEMPLARY EMBODIMENTS

Advantages and features of the present invention and methods for achieving them will be made clear from embodiments described in detail below with reference to the accompanying drawings. However, the present invention may be embodied in many different forms and should not be construed as being limited to the embodiments set forth herein. Rather, these embodiments are provided so that this disclosure will be thorough and complete and will fully convey the scope of the present invention to those of ordinary skill in the technical field to which the present invention pertains. The present invention is defined by the claims. Meanwhile, terms used herein are for the purpose of describing the embodiments and are not intended to limit the present invention. As used herein, the singular forms include the plural forms as well unless the context clearly indicates otherwise. The term “comprise” or “comprising” used herein does not preclude the presence or addition of one or more other elements, steps, operations, and/or devices other than stated elements, steps, operations, and/or devices.

Although the terms first, second, etc., may be used to describe various elements, these elements should not be limited by these terms. These terms are used only to distinguish one element from another element. For example, a first element could be termed a second element and a second element could be termed a first element likewise without departing from the teachings of the present invention.

It will be understood that when an element is referred to as being “connected to” or “coupled to” another element, the element can be directly connected or coupled to another element or intervening elements. On the contrary, when an element is referred to as being “directly connected to” or “directly coupled to” another element, there are no intervening elements present. Other expressions describing the relationship between elements, such as “between” and “directly between” or “adjacent to” and “directly adjacent to”, should be interpreted similarly.

In addition, in describing the present invention, if it is determined that a detailed description of a related known technology may unnecessarily obscure the gist of the present invention, the detailed description thereof will be omitted.

The list of references of the present invention is as follows [1] to [6]. In this specification, each reference or the methodology proposed in each reference may be referred to by the number assigned to each reference as follows. The entire contents of references [1] to [6] are incorporated herein by reference.
[1] Wei, J. et al. Chain-of-Thought Prompting Elicits Reasoning in Large Language Models. in Advances in Neural Information Processing Systems vol. 35 24824-24837 (2022).
[2] Kojima, T. et al. Large Language Models are Zero-Shot Reasoners. in Advances in Neural Information Processing Systems vol. 35 22199-22213 (2022).
[3] Wang, P. et al. SCOTT: Self-Consistent Chain-of-Thought Distillation. in Proceedings of the 61st Annual Meeting of the Association for Computational Linguistics (Volume 1: Long Papers) 5546-5558 (2023).
[4] Li, L. H. et al. Symbolic Chain-of-Thought Distillation: Small Models Can Also “Think” Step-by-Step. in Proceedings of the 61st Annual Meeting of the Association for Computational Linguistics (Volume 1: Long Papers) 2665-2679 (2023).
[5] Wang, L. et al. A Survey on Large Language Model based Autonomous Agents. Preprint at http://arxiv.org/abs/2308.11432 (2023).
[6] Wang, X. et al. Self-Consistency Improves Chain of Thought Reasoning in Language Models, ICLR 2023.

Hereinafter, exemplary embodiments of the present invention will be described in detail with reference to the accompanying drawings. In order to facilitate overall understanding in describing the present invention, the same reference numerals will be used for the same means regardless of the reference numerals.

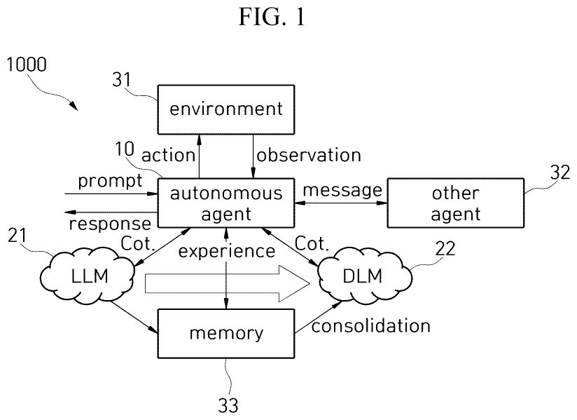

FIG. 1 is a conceptual diagram illustrating an autonomous agent system according to the present invention. An autonomous agent system 1000 according to an embodiment of the present invention may operate based on a large language model (LLM). The autonomous agent system 1000 may be implemented using a digital signal processor (DSP), a field programmable gate array (FPGA), or an application specific integrated circuit (ASIC), as well as a computing device such as a server, a personal computer, or a portable terminal.

The autonomous agent system 1000 may be configured to operate an autonomous agent 10 and other agents 32 through execution of input or pre-stored commands, and to allow the autonomous agent 10 and/or the other agents 32 to communicate with an LLM 21, a domain language model (DLM) 22, an environment 31, the other agents 32, and a memory 33. The autonomous agent 10 and the other agents 32 may be codes that operate on hardware or a processor 1010 embedded within the autonomous agent system 1000, or may be external devices such as robots that operate under the control of the autonomous agent system 1000.

In this specification, a hardware or software component that interacts with the autonomous agent 10 or the other agents 32 is referred to as an “interaction target.”

For example, the interaction target of the autonomous agent 10 includes at least one of the environment 31, the other agents 32, the memory 33, the LLM 21, and the DLM 22, or a combination thereof.

The LLM 21 or the DLM 22 may be embedded within the autonomous agent system 1000 or may be operated in a system existing outside the autonomous agent system 1000.

The environment 31 is a tool utilized by the autonomous agent 10. The autonomous agent 10 interacts with the environment 31. The environment 31 may be a device, system, or DB outside the autonomous agent system 1000, and may be operated by resources that the autonomous agent system 1000 has. The environment 31 has a state and receives an action (means an action message) from the autonomous agent 10. Here, the state of the environment 31 may be changed or maintained as it is due to the action. The autonomous agent 10 receives observation and reward from the environment 31 for each time interval (step).

The other agents 32 are agents that have the same configuration as the autonomous agent 10 but have different profiles from the autonomous agent 10. The other agents 32 internally have a different profile from the autonomous agent 10 and thus perform a different role from the autonomous agent 10.

The other agents 32 may communicate with the LLM 21, the DLM 22, the environment 31, another agent, and the memory 33. As another example, the other agents 32 may be configured to communicate with the autonomous agent 10 and another DLM 22′ and/or another environments 31′. That is, the other agents 32 may input a prompt to the DLM 22′ to acquire a response, transmit an action to the environment 31′, and acquire an observation from the environment 31′. In addition, the other agents 32 may perform all the functions that are performed by the autonomous agent 10. For example, the other agents 32 mat expand the prompt by utilizing a CoT prompting technique or a self-consistency technique.

The autonomous agent 10 receives an original prompt from a user or an external device and outputs a response in response to the received original prompt. The autonomous agent 10 may generate the response using the LLM 21 based on the original prompt.

In this specification, it is assumed that the input prompt of the autonomous agent 10 is a set of sentences in text form. The output of the autonomous agent 10 may be words or sentences.

The environment 31 of the autonomous agent 10 may be an external tool utilized by the autonomous agent 10 or a dynamic environment with a state such as a maze or a board game. The autonomous agent 10 transmits an action to the environment 31 and receives an observation corresponding to the action from the environment 31.

The autonomous agent 10 divides a task included in the prompt into subtasks using the LLM 21.

The autonomous agent 10 may acquire a chain-of-thought (CoT) including a subtask sequence from the LLM 21 by applying a CoT prompting technique to the LLM 21. Here, the subtask sequence is a sequence of subtasks for a task specified in an original prompt. The autonomous agent 10 expands the prompt by adding the subtask sequence and information obtained as a result of executing the subtask sequence.

The subtask sequence may include an action for the environment 31. The autonomous agent 10 may transmit the action to the environment 31 and receive an observation corresponding to the action from the environment 31. The observation may be a current state of the autonomous agent 10 in the environment 31. The interaction between the autonomous agent 10 and the environment 31 progresses through the action. In this case, the observation becomes the execution result of the action (the execution result of the subtask).

For example, the autonomous agent 10 may be a cooking robot equipped with an autonomous driving body, and the actions may be “turn right,” “step forward,” etc., and the observation may be recognition information that an electric oven is currently in front of the cooking robot.

The autonomous agent 10 may supplement the prompt by adding the observation to the prompt, and input the supplemented prompt into the LLM to generate a response. The autonomous agent 10 stores the log derived from this process, that is, a pair of the expanded prompt and response, as an experience in the memory 33. Depending on the training direction of the DLM 22, the experience may include the original prompt instead of the expanded prompt, or may include all of the original prompt, the expanded prompt, and the response.

The autonomous agent 10 performs sampling on the experience stored in the memory 33 and performs distillation to transmit the knowledge of the LLM 21 to the DLM 22 by utilizing the sampling result. Through this, the memory 33 is consolidated into the DLM 22, and the DLM 22 gradually replaces the role of LLM 21. The distillation process is executed in a periodic autonomous growth manner.

The other agents 32 are agents with a different profile and environment from the autonomous agent 10 and perform a different role from the autonomous agent 10. The other agents 32 may also communicate with an LLM, a DLM, a memory, an environment, and another agent. The LLM that communicates with the other agents 32 may be the LLM 21 that communicates with the autonomous agent 10.

As described above, the autonomous agent 10 and the other agents 32 may communicate with each other. The autonomous agent 10 may acquire a prompt to be transmitted to the other agents 32 from the LLM 21 based on the original prompt and transmit the acquired prompt to the other agents 32. When the other agents 32 transmit a response to the above prompt, the autonomous agent 10 may perform prompt expansion by adding the prompt transmitted to the other agents 32 and the response received from the other agents 32 to the original prompt or the expanded prompt. The autonomous agent 10 may input the expanded prompt to the LLM 21 to acquire the response.

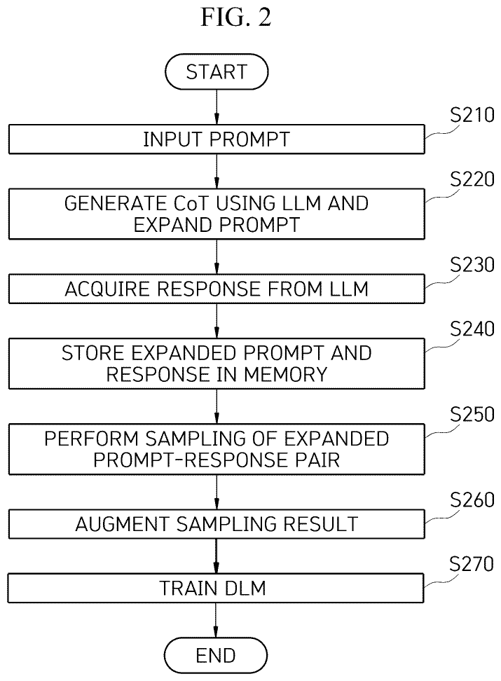

FIG. 2 is a diagram illustrating a method of training a domain language model (DLM) according to an embodiment of the present invention. The above method of graining the DLM is a method of training the DLM through distillation of an LLM according to the operation of an autonomous agent and is performed by an autonomous agent system 1000.

The method of training the DLM according to an embodiment of the present invention includes operations S210 to S270. The method of training the DLM illustrated in FIG. 2 is performed according to an embodiment, and the operations of the method of training the DLM according to the present invention are not limited to the embodiment illustrated in FIG. 2, and some operations may be added, changed, or omitted as needed.

Operations S210 to S240 are related to a process of acquiring an expanded prompt-response pair through input/output processing for the LLM 21.

In operation S210, a prompt is input. In this operation, the autonomous agent 10 receives an original prompt from an external device or a user.

For example, the original prompt is related to user sleep information and may be given in the following form.

prompt: Q1=“I'm trying to get 7 hours of sleep, but I think I woke up about 3 times during the night. I'm a little tired.”

In operation S220, the prompt is expanded.

The autonomous agent 10 generates a first expanded prompt by adding an instruction including an interaction target to the original prompt. Here, the instruction has the nature of an additional question that enables the LLM 21 to derive an appropriate response (answer) to the prompt (question). The reason for specifying the interaction target is to enable the LLM 21 to generate a subtask sequence that reflects the use of the interaction target, so that when the own results of the LLM 21 are insufficient, subtask execution result information may supplement the results of the LLM 21.

For example, the autonomous agent 10 may generate the first expanded prompt by expanding the original prompt in a manner that the environment 31, the other agents 32, and the memory 33 are specified as the interaction targets in the instruction. In addition, the autonomous agent 10 may also expand the original prompt in a manner that the DLM 22 is specified as the interaction target in the instruction.

For example, the autonomous agent 10 may generate the first expanded prompt as follows by specifying the environment 31 as the interaction target in the instruction.

prompt: Q1, INST1={User sleep information ENV}

The above first expanded prompt includes an original prompt Q1 and an instruction INST1, and the instruction INST1 includes a main task (a task that checks “user sleep information”) corresponding to the original prompt and an interaction target (“ENV” means environment). The autonomous agent 10 may determine the main task by itself or through the LLM 21. The interaction target included in the instruction may be determined by the setting, and when information on the interaction target of the autonomous agent 10 is given to the LLM 21, the information on the interaction target may be determined by the LLM 21.

In the example of the above first expanded prompt, the reason why the environment 31 is designated as the interaction target is because the user's sleep information does not exist in the LLM 21 itself. That is, in this case, the environment 31 acts as a tool for generating an answer to a question (original prompt). In practice, when the autonomous agent system 1000 is implemented, the environment 31 may be an API that continuously provides sleep information, which is mounted on a wearable device including a sleep sensor.

In addition, the autonomous agent 10 acquires a CoT including a subtask to be executed on the interaction target from the LLM using the CoT prompting technique based on the first expanded prompt in which the interaction target is specified. Specifically, the autonomous agent 10 utilizes the first expanded prompt to generate a prompt that causes the LLM 21 to divide the main task specified in the first expanded prompt into one or more subtasks, inputs the generated prompt into the LLM 21, and acquires a CoT including a subtask sequence for executing the main task from the LLM 21.

For example, a CoT including a subtask sequence (1, 2) to be executed in response to user sleep information may be configured as follows. In a specific subtask (e.g., checking user sleep score) from the subtask sequence, an interaction target may be specified.

CoT={1. ENV Check user sleep score, 2. Sleep cycle feedback}

The autonomous agent 10 may acquire the CoT including the subtask sequence from the LLM 21 using the CoT prompting technique based on the first expanded prompt, and then extract the subtask that can be executed on the interaction target specified in the first expanded prompt from the subtask sequence. When the interaction target is the environment 31, the subtask becomes an action to be transmitted to the environment 31, and when the interaction target is the other agents 32, the subtask becomes a message (e.g., a prompt) to be transmitted to the other agents 32. In addition, when the interaction target is the memory 33, the subtask becomes a query for the memory 33. In other words, the LLM 21 may provide the action to be transmitted to the environment 31, the message to be transmitted to the other agents 32, and the query to be transmitted to the memory 33. Here, the query means a query that can be retrieved from the memory 33. The message that the other agents 32 transmit to the autonomous agent 10 may be composed of a response to the received prompt or a pair of the received prompt and its response. In addition, a query to the memory 33 may be for extracting experiences (prompt-response pairs) stored in memory 33, and when step-by-step experiences of the autonomous agent 10 or the other agents 32 are stored in the memory 33, recent memory information (recently stored experiences) may be extracted from step-by-step experience information through the query.

Thereafter, the autonomous agent 10 executes the subtask on the LLM 21 or another interaction target to acquire subtask execution result information and adds the subtask execution result information to the first expanded prompt to generate a second expanded prompt. In this process, the autonomous agent 10 may further include the subtask sequence, i.e., the CoT, in the second expanded prompt.

For example, when the autonomous agent 10 transmits an action such as “check user sleep score” to the environment 31 and acquires an observation that the user sleep score is “good” from the environment 31, the autonomous agent 10 may add the subtask sequence and the observation (subtask execution result information) to the first expanded prompt to generate the second expanded prompt as follows.

prompt: Q1, INST1, CoT={1. ENV Check user sleep score=good, 2. Sleep cycle feedback}

Meanwhile, the autonomous agent 10 may generate the second expanded prompt by adding an example for in-context learning as well as the subtask sequence and the subtask execution result information to the first expanded prompt.

In operation S230, a response is acquired from the LLM. The autonomous agent 10 inputs the second expanded prompt into the LLM 21 to acquire a response from the LLM 21.

For example, the LLM 21 may output the following response to the second expanded prompt.

response=“The quality of sleep is getting better. It doesn't matter much if you wake up every two hours in sleep cycle.”

In operation S240, a pair of the expanded prompt-response is stored in the memory. The autonomous agent 10 converts the pair of the second expanded prompt and its response, which was input to the LLM 21, into an experience format and stores the converted data in the memory 33 as learning data of the DLM 22.

An example of the experience format is as follows.

{prompt= . . . , response= . . . }

Hereinafter, operations S250 to S270 will be described. Operations S250 to S270 relate to a process of distilling knowledge of the LLM 21 into the DLM 22.

In operation S250, sampling may be performed on the pair of the expanded prompt and response. The autonomous agent 10 performs sampling of the pair of the expanded prompt (second expanded prompt) and response stored in the memory 33. That is, the autonomous agent 10 extracts a sample of the pair of the expanded prompt-response from the memory 33.

In operation S260, the result of the sampling is augmented. The autonomous agent 10 augments the sampling result using the LLM 21. The autonomous agent 10 augments the sampling result by additionally securing various prompts that elicit a target response (response included in the sampling result) by applying the CoT prompting technique (CoT exploration) and the self-consistency strategy (see reference [6]). Here, the self-consistency is a strategy proposed by Wang et al. [6], which is an approach that generates and utilizes various reasoning chains that have correct answers matching the target prompt. The self-consistency is a strategy that utilizes the intuition that complex reasoning problems allow various ways of thinking that typically lead to unique correct answers.

For example, the autonomous agent 10 may augment the sampling result by additionally acquiring multiple prompts that elicit the target response from the LLM 21 using multiple predetermined CoT prompts (i.e., applying the CoT prompting technique) and generating pairs of the additionally acquired multiple prompts and target responses.

In operation S270, the DLM is trained. The autonomous agent 10 trains the DLM 22 using the sampling result extracted in operation S250 or the pairs of prompts and responses augmented in operation S260. In this embodiment, the case where the second expanded prompt-response pair is used for training the DLM 22 has been described, but as another example, the pair of the original prompt or the first expanded prompt and its response may be used for training the DLM 22.

Here, the autonomous agent 10 may reflect, in the training of the DLM 22, a pair of the action transmitted to the environment 31 and the corresponding observation (action-observation pair), which is included in the prompt, and a pair of a message transmitted to the other agents 32 and a message received from the other agents 32 (prompt-response pair). Next, after the training of the DLM 22 is completed, the autonomous agent 10 deletes the already sampled prompt-response pair from the memory 33. In the process of deleting the sampled prompt-response pair from the memory 33, a verification of the DLM 22 consolidation may be added. That is, depending on whether the DLM 22 can reproduce the prompt-response pair that is the deletion target, whether to delete the sampled prompt-response pair may be determined. In other words, in a case in which the DLM 22 can output a response matching the sampled prompt (deletion target) when the sampled prompt (deletion target) is input to the DLM 22, the target prompt-response pair is deleted from the memory 33. This is because information that can be reproduced by the DLM 22 no longer needs to be trained.

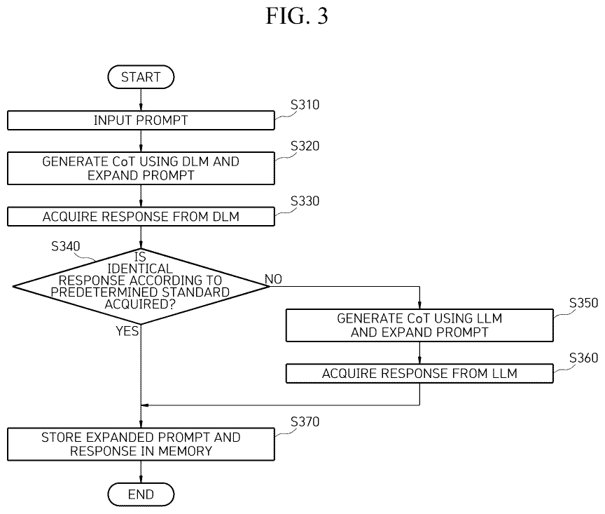

FIG. 3 is a diagram illustrating a method of acquiring a response using a DLM according to an embodiment of the present invention.

According to an embodiment of the present invention, a method of acquiring a response using a DLM includes operations S310 to S370. The method of acquiring the response is a method of acquiring an expanded prompt-response pair through input/output processing for the DLM 22. Operations S310 to S370 may be performed after operation S270 of FIG. 2. That is, the method of acquiring the response using the DLM according to the embodiment of FIG. 3 may be combined with the method of training the DLM according to the embodiment of FIG. 2.

The method of acquiring the response using the DLM, as shown in FIG. 3, is performed according to an embodiment, and the operations of the method of acquiring the response using the DLM according to the present invention are not limited to the embodiment shown in FIG. 3, and some operations may be added, changed, or omitted as needed.

In operation S310, a prompt is input. In this operation, the autonomous agent 10 receives an original prompt from an external device or user.

In operation S320, the prompt is expanded using a DLM. The autonomous agent 10 generates a first expanded prompt by expanding the original prompt in a manner that specifies the use of an interaction target in an instruction. The autonomous agent 10 may generate multiple first expanded prompts in a manner that specifies each interaction target differently.

Next, the autonomous agent 10 acquires a CoT including a subtask to be executed on the interaction target from the DLM 22 using a CoT prompting technique based on the first expanded prompt.

For example, the DLM 22 may generate a CoT including all subtasks, such as an action on the environment 31, a message to the other agents 32, and a query on the memory 33, or may generate a CoT including each of the above subtasks.

As another example, the autonomous agent 10 may generate multiple CoTs from the DLM 22 using multiple predetermined CoT prompts. As described above, the CoT may include multiple subtasks.

The autonomous agent 10 executes a subtask on the DLM 22 or another interaction target to acquire subtask execution result information and adds the subtask execution result information to a first expanded prompt to generate a second expanded prompt.

The autonomous agent 10 may acquire multiple second expanded prompts according to operation S320.

Operation S320 is a modification of operation S220 in FIG. 2, where the language model being utilized is changed to the DLM 22. Here, more details thereof can be understood by referring to the description made in operation S220. In addition, additional description in operation S320 may also be applicable to operation S220.

In operation S330, a response is acquired from the DLM. The autonomous agent 10 inputs the second expanded prompt to the DLM 22 to acquire a response. The autonomous agent 10 may generate multiple second expanded prompts through various methods, such as adding a result (observation) of an action on the environment 31, a result from the other agents 32, recent information on the memory 33, or acquiring subtask execution result information from the LLM 21 or the DLM 22, and may input the multiple second expanded prompts to the DLM 22 to generate multiple responses.

In operation S340, whether the identical response is secured according to a predetermined standard is determined. For example, the autonomous agent 10 applies the self-consistency strategy (see reference [6]) and, when the largest number of identical responses among multiple responses is greater than or equal to a predetermined percentage, the response with the largest number of identical responses may be determined as a final response, and a pair of the second expanded prompt that led to the final response and the final response may be converted into an experience format and stored in the memory 33 in operation S370. When the largest number of identical responses is less than the predetermined percentage, the autonomous agent 10 performs operation S350.

In operation S350, the prompt is expanded using the LLM 21.

The autonomous agent 10 generates a first expanded prompt by expanding the original prompt in a manner that specifies the use of the interaction target in the instruction. The autonomous agent 10 may generate multiple first expanded prompts in a manner that specifies each interaction target differently.

The autonomous agent 10 acquires a CoT including a subtask to be executed on the interaction target from the LLM 21 using a CoT prompting technique based on the first expanded prompt.

For example, the LLM 21 may generate a CoT including all subtasks such as an action for the environment 31, a message for the other agents 32, and a query for the memory 33, or generate a CoT including each of the subtasks.

As another example, the autonomous agent 10 may generate multiple CoTs from the LLM 21 using multiple predetermined CoT prompts. As described above, the CoTs may include multiple subtasks.

The autonomous agent 10 executes the subtask on the LLM 21 or another interaction target to acquire subtask execution result information and adds the subtask execution result information to the first expanded prompt to generate the second expanded prompt.

According to operation S350, the autonomous agent 10 may acquire multiple second expanded prompts. Even if the content is not described in this operation, the content described in operation S220 or S320 may be applied to this operation.

In operation S360, a response is acquired from the LLM. The autonomous agent 10 inputs the second expanded prompt to the LLM 21 to acquire a response. The autonomous agent 10 may generate multiple second expanded prompts by various methods, such as adding a result (observation) of the action on the environment 31, a result from the other agents 32, and recent information on the memory 33, or acquiring subtask execution result information from the LLM 21, and may input the multiple second expanded prompts into the LLM 21 to generate multiple responses. The autonomous agent 10 may determine the response with the largest number of identical responses among the multiple responses as a final response.

In operation S370, the expanded prompt and the response are stored in the memory.

The autonomous agent 10 converts a pair of the second expanded prompt that led to the final response and the final response into an experience format and stores the converted data in the memory 33.

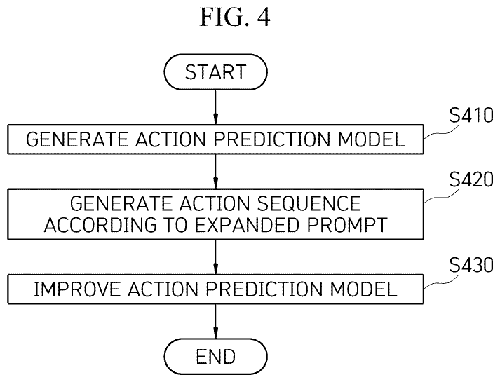

FIG. 4 is a diagram illustrating a method of improving an action prediction model of an autonomous agent according to an embodiment of the present invention. The method of improving the action prediction model illustrated in FIG. 4 is a method of improving the action prediction model used by the autonomous agent to improve the performance of the autonomous agent and includes operations S410 to S430.

The method of improving the action prediction model according to the embodiment of FIG. 4 may be performed independently of FIG. 2 and FIG. 3. For example, the method of improving the action prediction model according to the embodiment of FIG. 4 may be performed before performing the method of training the DLM according to an embodiment of the present invention or may be performed after performing the method of training the DLM.

The above-mentioned action prediction model is a model that predicts an action or action sequence that the autonomous agent 10 can take with respect to the environment 31 when a prompt is given. The action is a type of subtask, and the action sequence is a type of subtask sequence. Therefore, the action prediction model may be utilized when the autonomous agent 10 wants to acquire the subtask sequence in operation S220 of FIG. 2.

Meanwhile, the LLM 21 or the DLM 22 may perform the role of the above-mentioned action prediction model.

The method of improving the action prediction model illustrated in FIG. 4 is performed according to an embodiment, and the operations of the method of improving the action prediction model according to the present invention are not limited to the embodiment illustrated in FIG. 4, and some operations may be added, changed, or omitted as needed.

In operation S410, an action prediction model is generated. In this operation, the autonomous agent 10 generates the prediction model. The autonomous agent 10 may designate the LLM 21 or the DLM 22 as the action prediction model or may separately generate a neural network-based action prediction model.

In operation S420, an action sequence is generated. The autonomous agent 10 inputs an initial prompt into the action prediction model to generate an action sequence. The initial prompt may be one of an original prompt, a first expanded prompt, and a second expanded prompt (a prompt that is input or generated while the method illustrated in FIG. 2 and FIG. 3 is performed). The autonomous agent 10 may extract the initial prompt to be input into the action prediction model from the memory 33.

After generating the action sequence, the autonomous agent 10 may add noise to some actions included in the action sequence so that a certain proportion of random actions are included in the action sequence. The higher the proportion of random actions included in the action sequence, the more exploration is strengthened. The autonomous agent 10 may generate various action sequences including a certain proportion of random actions by varying the method of adding noise to the action sequence.

In addition, the autonomous agent 10 may generate various action sequences by inputting a random seed into the action prediction model.

In operation S430, the action prediction model is improved.

The autonomous agent 10 expands the prompt by adding the generated action sequence to the initial prompt and inputs the expanded prompt into the LLM 21 or the DLM 22 to acquire a response.

The autonomous agent 10 improves the action prediction model by using the self-consistency value of the LLM 21 or the DLM 22 as a reward. For example, when multiple responses are acquired through the LLM 21 or the DLM 22, the autonomous agent 10 may generate a final action sequence by weighting the action sequences by assigning relatively high weights to action sequences with many identical responses and relatively low weights to action sequences with few identical responses, and then train the action prediction model based on a pair of the initial prompt and the final action sequence. As another example, the autonomous agent 10 may determine a loss function value according to the same number of responses, and train the action prediction model based on the determined loss function value.

In addition, the autonomous agent 10 may borrow and utilize various rewards suitable for the environment 31 depending on the application. For example, the autonomous agent 10 may train the action prediction model by using the result value (observation) that the environment 31 feeds back for multiple action sequences, as a reward. For example, in a case in which a specific game is assumed as the environment 31, when the environment 31 outputs a game score by applying the action sequence to the environment 31, the autonomous agent 10 may train the action prediction model by using this game score as a reward.

In addition, the autonomous agent 10 may improve the action prediction model by applying the self-consistency value and the reward of the environment 31 in combination. That is, by reflecting the self-consistency value (giving a high value to the action sequence with many identical responses) and the reward of the environment 31 in the loss function, the action prediction model may be trained based on the corresponding loss function value.

The above method of training the DLM, method of acquiring the response using the DLM, and method of improving the behavior prediction model have been described with reference to the flowcharts presented in the drawings. For simplicity, the above methods have been illustrated and described as a series of blocks, but the present invention is not limited to the order of the blocks, and some blocks may occur in a different order or concurrently with other blocks than illustrated and described herein, and various other branches, flow paths, and orders of blocks may be implemented that achieve the same or similar results. In addition, not all of the illustrated blocks may be required to implement the methods described herein.

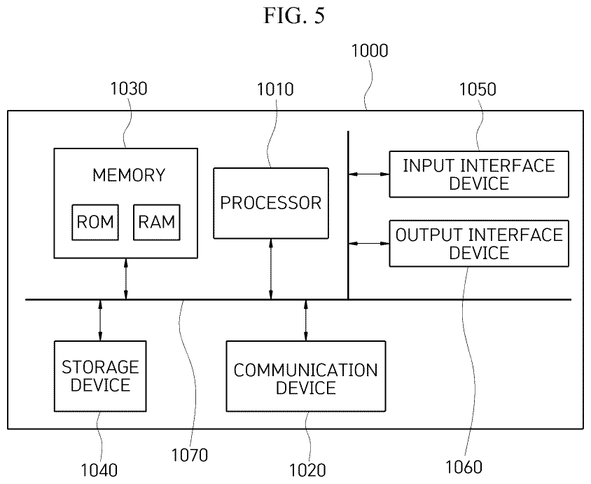

Meanwhile, in the description referring to FIGS. 2 to 4, each operation may be further divided into additional operations or combined into fewer operations according to the implementation example of the present invention. In addition, some operations may be omitted as needed, and the order of the operations may be changed. In addition, even if other omitted contents are present, the contents of FIG. 1 or FIG. 5 may be applied to the contents of FIG. 2 to FIG. 4. In addition, the contents of FIG. 2 to FIG. 4 may be applied to FIG. 1 or FIG. 5.

FIG. 5 is a block diagram illustrating the configuration of an autonomous agent system according to an embodiment of the present invention. The autonomous agent system 1000 is a system that performs LLM distillation and DLM training based on the autonomous agent.

The autonomous agent system 1000 performs the method of training the DLM, the method of acquiring the response using the DLM, and the method of improving the action prediction model, which have already been described with reference to FIGS. 1 to 4.

The autonomous agent system 1000 according to an embodiment of the present invention may be implemented in the form illustrated in FIG. 5.

Referring to FIG. 5, the autonomous agent system 1000 may include at least one of a processor 1010, a memory 1030, an input interface device 1050, an output interface device 1060, and a storage device 1040 which perform communication via a bus 1070. The autonomous agent system 1000 may further include a communication device 1020 coupled to a network. The processor 1010 may be a central processing unit (CPU), or a semiconductor device that executes instructions stored in the memory 1030 or the storage device 1040. The memory 1030 may perform the function of the memory 33 of FIG. 1. The memory 1030 and the storage device 1040 may include various forms of volatile or nonvolatile storage media. For example, the memory 1030 may include a read-only memory (ROM) or a random access memory (RAM). In the embodiment of the present disclosure, the memory 1030 may be located inside or outside the processor 1010, and the memory 1030 may be connected to the processor 1010 through various means already known. The memory 1030 may be various forms of volatile or nonvolatile storage media, for example, the memory 1030 may include an ROM or an RAM.

Accordingly, embodiments of the present invention may be implemented as a computer-implemented method or as a non-transitory computer-readable medium having computer-executable instructions stored thereon. In an embodiment, the computer-readable instructions, when executed by a processor, may perform a method according to at least one aspect of the present disclosure.

The communication device 1020 may transmit or receive a wired signal or a wireless signal.

In addition, the method according to the embodiment of the present invention may be implemented in the form of a program command that can be executed through various computer means and recorded on a computer-readable medium.

The computer-readable medium may include program commands, data files, data structures, etc., alone or in combination. The program commands recorded in the medium may be those specially designed or configured for the embodiments or those known to and available by those skilled in the computer software field. Examples of the computer-readable recording medium may include magnetic media, such as a hard disk, a floppy disk, or magnetic tape, optical media, such as a compact disc (CD) read-only memory (ROM) or a digital versatile disc (DVD), magneto-optical media, such as a floptical disk, and hardware devices configured to store and execute program commands such as a ROM, a random access memory (RAM), and a flash memory. Examples of the program commands may include high-level language code which can be executed by a computer using an interpreter and the like as well as machine language code generated by a compiler.

The autonomous agent system 1000 according to an embodiment of the present invention may train the DLM 22 based on the LLM 21, acquire a response to a given prompt using the DLM 22, and improve an action prediction model. The autonomous agent system 1000 includes the memory 1030 storing computer-readable instructions and the at least one processor 1010 configured to execute the instructions. The memory 1030 may perform the functions of the memory 33.

The at least one processor 1010 may be configured to execute the commands that cause the autonomous agent 10 to receive an original prompt and generate a first expanded prompt by adding an instruction including an interaction target to the original prompt, acquire a CoT including a subtask to be executed on the interaction target from an LLM using a CoT prompting technique based on the first expanded prompt, acquire subtask execution result information by executing the subtask on the interaction target and generate a second expanded prompt by adding the subtask execution result information to the first expanded prompt, and acquire a response by inputting the second expanded prompt to the LLM 21 and store a pair of the second expanded prompt and the response in the memory 1030 as training data of the DLM 22.

In an embodiment of the present invention, the at least one processor 1010 may be configured to cause the autonomous agent 10 to perform sampling of a pair of an expanded prompt and a response from the memory 1030, and to train the DLM 22 using a result of the sampling.

In an embodiment of the present invention, the at least one processor 1010 may be configured to cause the autonomous agent 10 to acquire the CoT including a subtask sequence from the LLM 21 using a CoT prompting technique based on the first expanded prompt in the process of acquiring the CoT, and to extract a subtask to be executed on the interaction target from the subtask sequence.

In an embodiment of the present invention, the interaction target may include at least one of the environment 31 of the autonomous agent, the memory 1030, and the other agents 32, or a combination thereof.

In an embodiment of the present invention, the at least one processor 1010 may be configured to cause the autonomous agent 10 to augment the result of the sampling by additionally deriving a prompt that allows a response included in the result of the sampling to be derived, from the LLM 21 by applying a self-consistency strategy.

In an embodiment of the present invention, when the environment 31 of the autonomous agent 10 is included in the interaction target, the at least one processor 1010 may be configured to cause the autonomous agent 10 to transmit a subtask to be executed on the environment as an action to the environment 31, and then add observation acquired from the environment 31 to the subtask execution result information.

In addition to the contents described above with reference to FIG. 5, the autonomous agent system 1000 may perform the operations described in FIG. 1 to FIG. 4 through the execution of the commands by the at least one processor 1010.

As described above, according to the present invention, the problem of dependency on the LLM, which is present in the existing LLM-based approach, is solved through distillation for the DLM.

In addition, the present invention provides a distillation method for the DLM in a structure where various environments are given and collaboration with various agents is possible by utilizing an agent framework. Accordingly, the present invention provides an approach that can replace the LLM by utilizing autonomous agent technology.

The effects obtainable from the present invention are not limited to the effects mentioned above, and other effects that are not mentioned will be clearly understood by those skilled in the art to which the present invention belongs from the description below.

For reference, the components according to the embodiment of the present invention may be implemented in the form of software or hardware such as a DSP, an FPGA, or an ASIC and may perform predetermined roles.

However, the ‘components’ are not limited to software or hardware, and each component may be in an addressable storage medium or may be configured to play one or more processors.

Accordingly, as an example, the “components” may include components such as software components, object-oriented software components, class components, and task components, and at least one of processes, functions, attributes, procedures, subroutines, program code segments, drivers, firmware, micro-codes, circuits, data, database, data structures, tables, arrays, and variables.

Furthermore, the components and functions provided in the components may be combined into a smaller number of components or may be further divided into additional components.

Meanwhile, it will be understood that each block of the flowchart drawings and combinations of the flowchart drawings can be performed by computer program instructions. These computer program instructions may be installed on a processor of a general-purpose computer, a special-purpose computer, or other programmable data processing apparatuses, so that the instructions executed by the processor of the computer or other programmable data processing equipment generate a means for performing the functions described in the flowchart block(s). Since the computer program instructions may be installed on a computer or other programmable data processing apparatus, a series of operational steps may be performed on the computer or other programmable data processing apparatus to produce a computer-implemented process, so that the instructions executing the computer or other programmable data processing apparatus may also provide steps for executing the functions described in the flowchart block(s).

In addition, each block may represent a module, segment, or portion of code that includes one or more executable instructions for executing a particular logical function(s). It should also be noted that in some alternative implementation examples, the functions mentioned in the blocks may occur out of order. For example, two blocks shown in succession may be executed substantially concurrently, or the blocks may sometimes be executed in reverse order, depending on the corresponding function.

Although the present invention has been described above with reference to exemplary embodiments thereof, it will be understood by those skilled in the art that various modifications and changes may be made to the present invention without departing from the spirit and scope of the present invention as set forth in the claims below.

What is claimed is:

1. A method of training a domain language model (DLM) using one or more processors configured to operate an autonomous agent by executing commands, the method comprising:
receiving, by the autonomous agent, an original prompt and generating a first expanded prompt by adding an instruction including an interaction target to the original prompt;
acquiring, by the autonomous agent, a chain-of-thought (CoT) including a subtask to be executed on the interaction target from a large language model (LLM) using a CoT prompting technique based on the first expanded prompt;
acquiring, by the autonomous agent, subtask execution result information by executing the subtask on the interaction target and generating a second expanded prompt by adding the subtask execution result information to the first expanded prompt; and
acquiring, by the autonomous agent, a response by inputting the second expanded prompt to the LLM and storing a pair of the second expanded prompt and the response in a memory as training data of the DLM.

2. The method of claim 1, further comprising:
performing, by the autonomous agent, sampling of a pair of an expanded prompt and the response in the memory; and
training, by the autonomous agent, the DLM using a result of the sampling.

3. The method of claim 1, wherein the acquiring of the CoT includes:
acquiring, by the autonomous agent, the CoT including a subtask sequence from the LLM using the CoT prompting technique based on the first expanded prompt; and
extracting, by the autonomous agent, a subtask that is executed on the interaction target from the subtask sequence.

4. The method of claim 1, wherein the interaction target includes at least one of an environment of the autonomous agent, the memory, and other agents, or a combination thereof.

5. The method of claim 2, wherein the training of the DLM includes augmenting, by the autonomous agent, the result of the sampling by additionally deriving a prompt that allows a response included in the result of the sampling to be derived, from the LLM by applying a self-consistency strategy.

6. The method of claim 1, wherein, when the environment of the autonomous agent is included in the interaction target, the generating of the second expanded prompt includes transmitting, by the autonomous agent, a subtask that is executed on the environment as an action to the environment, and then adding observation acquired from the environment to the subtask execution result information.

7. An autonomous agent system that trains a domain language model (DLM), comprising:
a memory configured to store computer-readable commands; and
at least one processor implemented to execute the commands,
wherein the at least one processor executes the commands that cause an autonomous agent to:
receive an original prompt and generate a first expanded prompt by adding an instruction including an interaction target to the original prompt;
acquire a chain-of-thought (CoT) including a subtask that is executed on the interaction target from an LLM using a CoT prompting technique based on the first expanded prompt;
acquire subtask execution result information by executing the subtask on the interaction target and generate a second expanded prompt by adding the subtask execution result information to the first expanded prompt; and
acquire a response by inputting the second expanded prompt to the LLM and store a pair of the second expanded prompt and the response in the memory as training data of the DLM.

8. The autonomous agent system of claim 7, wherein the at least one processor is configured to cause the autonomous agent to:
perform sampling of a pair of an expanded prompt and the response in the memory; and
train the DLM using a result of the sampling.

9. The autonomous agent system of claim 7, wherein the at least one processor is configured to cause the autonomous agent to:
acquire the CoT including a subtask sequence from the LLM by using a CoT prompting technique based on the first expanded prompt in a process of acquiring the CoT; and
extract a subtask that is executed on the interaction target from the subtask sequence.

10. The autonomous agent system of claim 7, wherein the interaction target includes at least one of an environment of the autonomous agent, the memory, and other agents, or a combination thereof.

11. The autonomous agent system of claim 8, wherein the at least one processor is configured to cause the autonomous agent to augment the result of the sampling by additionally deriving a prompt that allows a response included in the result of the sampling to be derived, from the LLM by applying a self-consistency strategy.

12. The autonomous agent system of claim 7, wherein, when the environment of the autonomous agent is included in the interaction target, the at least one processor is configured to cause the autonomous agent to transmit a subtask that is executed on the environment as an action to the environment, and then add observation acquired from the environment to the subtask execution result information.
